(19) United States
(12) Patent Application Publication
(10) Pub. No.: US 2014/0223430 A1
(43) Pub. Date: Aug. 7, 2014

(54) METHOD AND APPARATUS FOR MOVING A SOFTWARE OBJECT

(71) Applicants: Matthew A. Stuempfle, Raleigh, NC (US); Jonathan David Gibson, Austin, TX (US)

(72) Inventors: Matthew A. Stuempfle, Raleigh, NC (US); Jonathan David Gibson, Austin, TX (US)

(73) Assignee: HEWLETT-PACKARD DEVELOPMENT COMPANY, L.P., Houston, TX (US)

(21) Appl. No.: 14/009,306

(22) PCT Filed: Apr. 7, 2011
(86) PCT No.: PCT/US11/31523

§ 371 Date: Oct. 1, 2013

(51) Int. Cl. G06F 9/455

(52) U.S. Cl. CPC G06F 9/45533
USPC 718/1

(57) ABSTRACT

According to one example of the present invention, there is provided a method of moving one of a plurality of software objects deployed among a plurality of object destinations in a computing system. The method comprises identifying a deployed software object to be moved to a new object destination, identifying a candidate object destination, identifying other software objects deployed on the candidate object destination, identifying a constraint associated with software object to be moved, identifying a constraint associated with software objects deployed on the candidate object destination, determining whether the identified constraints are compatible, and authorizing the move of the software object to be moved where it is determined that the constraints are compatible.

### BACKGROUND

Many organizations and enterprises are making ever increasing use of data centers and server virtualization technology to run their information technology (IT) applications in so-called virtualized environments. To help manage the IT applications within a data center there exist numerous virtualization tools, such as Hewlett-Packard's Matrix Operating Environment (Matrix OE), that automatically manage application deployment and redeployment within virtualized environments. Such virtualization tools enable the efficient management of data centers by enabling IT applications and virtual machines (VM) on which the IT applications run to be dynamically moved to different physical machines (PM) in the data center, whilst the applications and virtual machines are running.

The redeployment of software applications and virtual machines to different physical machines in a data center may be based on various characteristics of the physical machines. For instance, a virtualization tool may decide to move a virtual machine to a different physical machine based on characteristics of the physical machine such as available memory, memory utilization, processing power, processor utilization, processor temperature, and so on. Accordingly, a physical machine with low processor utilization may, for example be shut down, thereby saving energy, and any virtual machines deployed thereon moved to another physical machine. Conversely, a physical machine with high processor utilization may be relieved of an application or virtual machine deployed thereon, by moving some of the virtual machines to another physical machine within the virtualized environment.

### BRIEF DESCRIPTION

Examples and embodiments of the invention will now be described, by way of non-limiting example only, with reference to the accompanying drawings, in which:

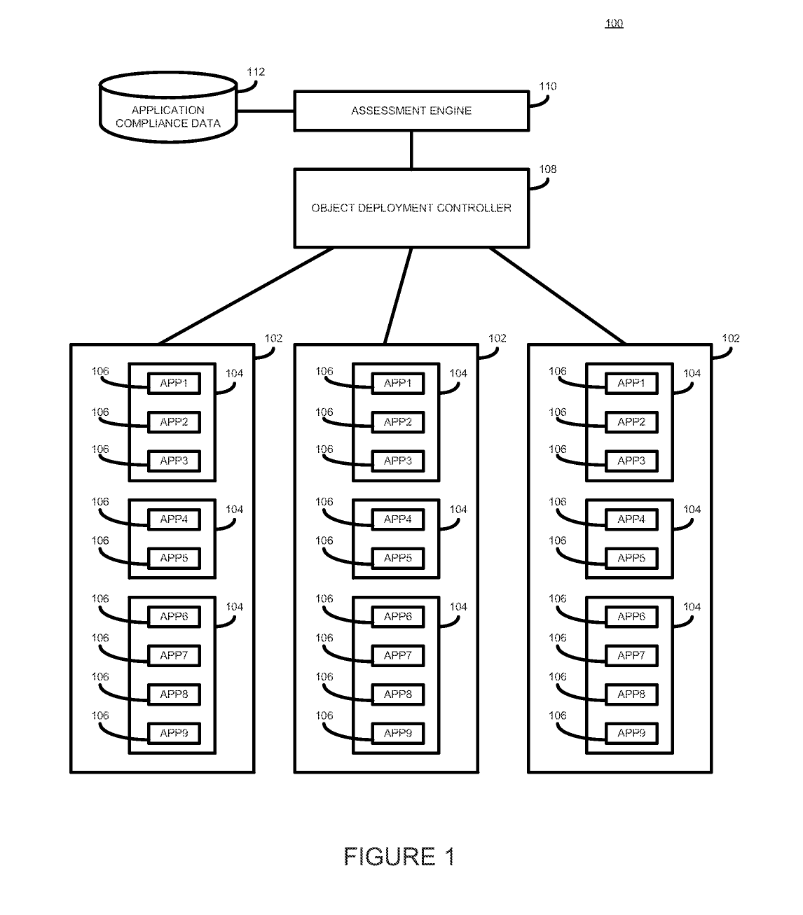

FIG. 1 is a simplified block diagram illustrating a system according to an example of the present invention;

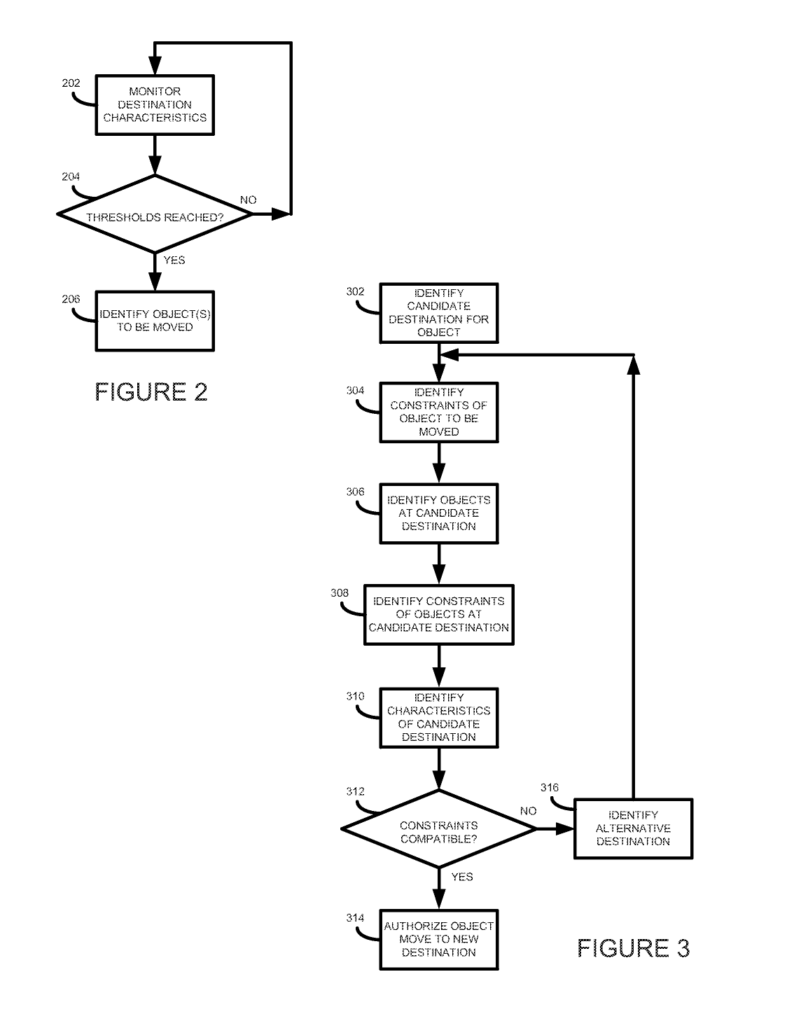

FIG. 2 is a simplified flow diagram outlining an example method of operating elements of the system of FIG. 1;

FIG. 3 is a simplified flow diagram outlining an example method of operating elements of the system of FIG. 1;

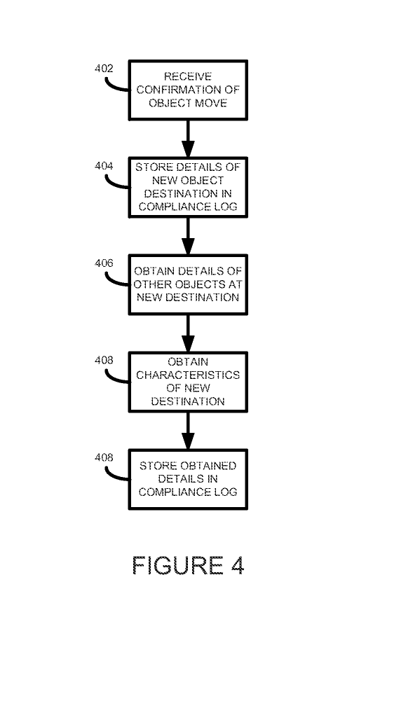

FIG. 4 is a simplified flow diagram outlining an example method of operating elements of the system of FIG. 1;

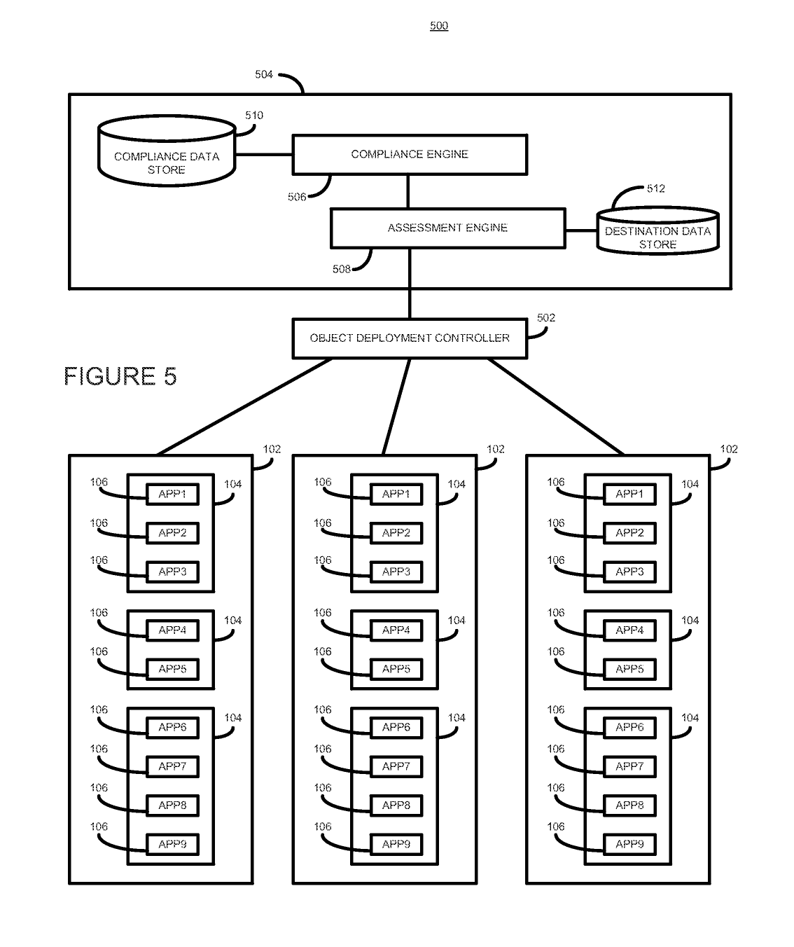

FIG. 5 is a simplified block diagram illustrating a virtualization management system according to an example of the present invention;

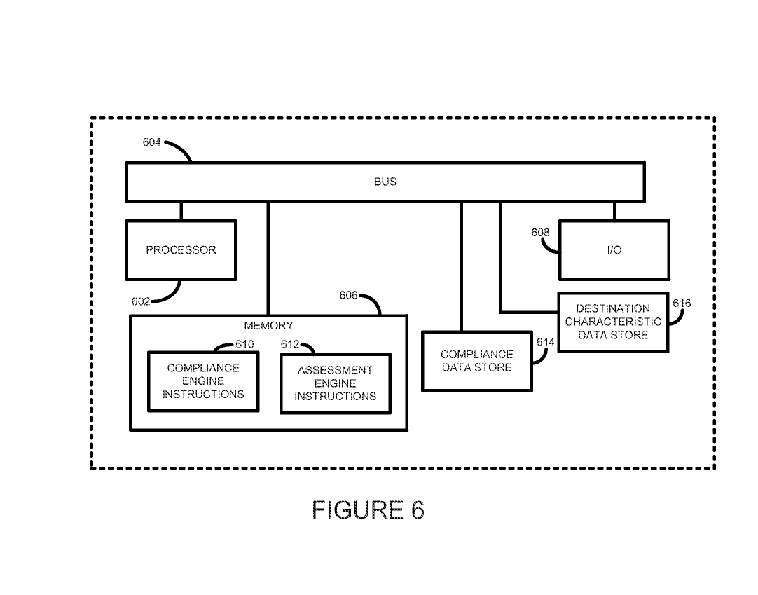

FIG. 6 is a simplified block diagram illustrating an implementation of a virtualization management system according to an example of the present invention; and

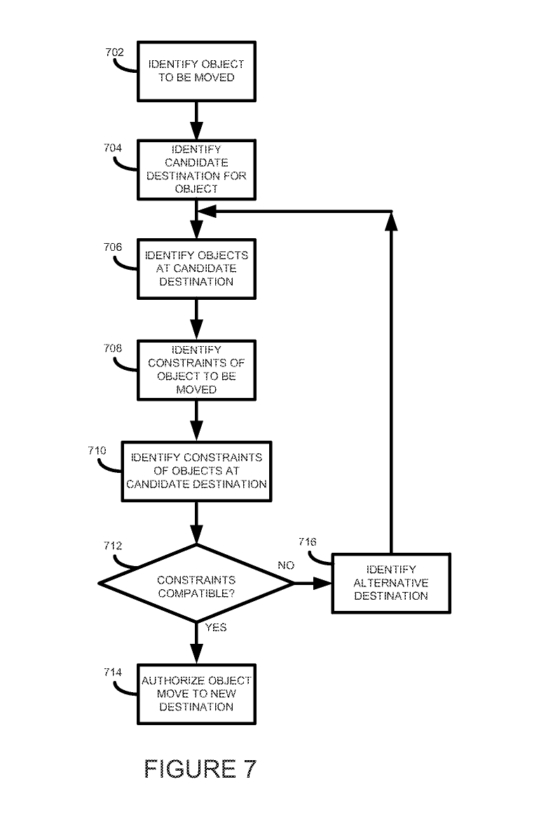

FIG. 7 is a simplified flow diagram outlining an example method of operating a virtualization management system according to an example of the present invention.

### DETAILED DESCRIPTION

Current virtualization management tools deploy and redeploy software applications and virtual machines based solely on characteristics of the virtual or physical machines on which the applications are deployed.

However, examples of the present invention aim to provide increased control over how software applications and virtual machines are redeployed or moved in a virtualized environment.

For example, the operation of certain types of software application or the processing of certain types of data may be subject to business constraints, regulatory constraints, legal constraints, security constraints, or the like. Such constraints may, for example, prohibit one software application from being deployed on the same virtual machine, or on the same physical machine, as another software application or type of software application, or on a virtual or physical machine having certain other characteristics.

For example, a software application that processes personal medical data may be constrained from running on a virtual or physical machine that is connected to a public network, such as the Internet, in order to avoid potential security risks. Similarly, a software application processing personally identifiable information (PII) may be constrained to being deployed on the same physical machine as a database server on which the PII data is stored. Likewise, a software application that complies with the payment card industry data security standards (PCI-DSS) data may have to comply with specific industry regulations.

Referring now to FIG. 1 there is shown a block diagram illustrating a virtualization management system 100 according to an example of the present invention. The operation of elements of FIG. 1 is described in further detail with additional reference to FIG. 2.

The system 100 comprises a number of software objects 106, such as software applications and computer programs, each of which is deployed on a virtual destination 104 such as a virtual machine or other software object execution environment. Each virtual destination 104 is in turn deployed on a hardware destination 102, such as a physical computing device, computer server or other processing device.

In one example, a virtual destination 104 may be deployed on a further virtual destination 104, which is in turn deployed on a hardware destination 102.

Since both software applications 106 and virtual destinations 104 are both kinds of software objects, the term software object may be used herein to cover both software applications 106 and virtual destinations 104.

The identification of which deployed software objects (104 and 106) are to be moved is performed by an object deployment controller 108. In one example the object deployment controller 108 may be a virtualization controller, such as a HP Matrix Operating Environment (OE) for HP-UX systems, provided by Hewlett-Packard Company. The object deployment controller 108 generates notifications, alerts, messages, or the like, that indicate to an assessment engine or module 110 the identified object to be moved. The assessment engine 110 then, as described further below, determines where the identified object is to be moved.

Referring now to FIG. 2, operation of the object deployment controller 108 according to an example of the present invention is described. At 202 the object deployment controller 108 monitors characteristics of the object destinations. The obtained monitored characteristics may be stored in a suitable memory or data store (not shown).

In one example, the object deployment controller 108 monitors (202) characteristics of a hardware destination 102 on which a software object is deployed. In a further example, the object deployment controller 108 monitors (202) characteristics of a virtual destination 104 on which a software object is deployed. In a yet further example, the object deployment controller 108 monitors (202) characteristics of both a hardware and a virtual destination on which a software object is deployed.

For a hardware destination 102 the monitored characteristics may include, for example, technical characteristics of the hardware destination 102 such as the available memory, memory utilization level, available processing power, processor utilization level, available storage capacity, storage utilization level, and the like. For a virtual destination 104 the characteristics may include available virtual memory, virtual memory utilization, virtual processing power available, virtual processor utilization level, and the like.

In one example details of the monitored characteristics may be obtained directly from the destinations, for example, using a suitable interface. In a further example, details of the monitored characteristics may be obtained from a centralized data repository (not shown), such as a configuration management database (CMDB).

Using the monitored characteristics the object deployment controller 108 determines (204) whether any of the monitored characteristics exceeds or falls below a predetermined threshold level. For example, if the processor utilization of a hardware destination exceeds an average of 70% over a period of 10 minutes, the object deployment controller 108 may determine to move one or more software objects to a different virtual or hardware destination. In other examples other thresholds and characteristics may be used.

At 206 the object deployment controller 108 identifies one or more software objects that are to be moved to a new destination. In one example, the object deployment controller 108 identifies one or several software objects deployed in a virtual destination 104 that are to be moved to a different virtual destination 104 on the same or a different hardware destination 102. In another example, the object deployment controller 108 identifies one or several virtual destinations 104 (and all of the software objects deployed thereon) to be moved to a different hardware destination 102.

The assessment engine 110 is used, once the object deployment controller 108 determines that a software object is to be moved, to determine a new destination for that software object. Operation of the assessment engine 110 according to an example of the present invention will now be described with additional reference to FIG. 3.

At 302 the assessment engine 110 identifies a new candidate, or new potential, destination for the identified software object to be moved. In one example the identification of a new candidate destination is determined by finding a destination in which the obtained monitored characteristics indicate that the software object may be moved to the new destination without causing any adverse consequences in the virtualized environment. For example, an adverse consequence may be, for example, causing a characteristic of a virtual or physical destination to exceed or drop below a predetermined level. For example, if the identified software object is known to require at least 4 Gb of memory, then a candidate destination having at least 4 Gb of available memory may be chosen. Other requirements of the software object, such as storage requirements, processing requirements, network requirements, and the like, may also be considered if appropriate.

In one example, the assessment engine identifies a candidate destination by interrogating the object deployment controller via a suitable interface, such as an application programming interface.

At 304 the assessment engine 110 identifies constraint data that identifies one or more constraints associated with the identified software object to be moved. The constraint data is stored in an object compliance data store or memory 112. The constraint data may, for example, be defined by the IT system operator, be defined by a customer on behalf of whom an object is deployed, or be obtained in any other appropriate manner. As previously described, the constraint data may define business constraints, regulatory constraints, legal constraints, security constraints, or the like. The constraint data may define technical and/or non-technical constraints.

At 306 the assessment engine 110 identifies any software objects at the candidate destination, and at 308 identifies, using the object compliance data store 112, constraints associated with each of the software objects identified at the candidate destination.

At 310 the assessment engine 110 identifies characteristics of the candidate destination. The characteristics identified may, for example, be based on constraints associated with the software object to be moved. For example, if a constraint associated with the software object to be moved is that no public network access be provided on the destination, the assessment engine 110 may identify whether the candidate destination has public network access. In one example the destination characteristics are obtained from the aforementioned data store or memory. In a further embodiment the destination characteristics may be obtained directly from a destination, for example through an appropriate interface or software application.

At 312 the assessment engine 110 determines whether the obtained object constraints and destination characteristics are compatible with one another.

If the assessment engine 110 determines that the constraints and destination characteristics are not compatible the assessment engine 110 identifies (316) an alternative candidate destination.

If, on the other hand, the assessment engine 110 determines that the constraints and destination characteristics are compatible the assessment engine 110 authorizes the object to be moved to the candidate destination.

In one example the authorization to move the object to the candidate destination, although with details of the candidate destination, is sent, or is made available to, the object deployment controller 108 which appropriately moves the object.

In a further example, the assessment engine 110 performs the move of the object to the candidate destination in an appropriate manner.

In a further example, described with additional reference to FIG. 4, the assessment engine 110 receives (402) confirmation that the object to be moved was moved, and additionally receives details of the object destination to which it was moved. At 404 the assessment engine 110 stores these details in a compliance log (not shown). The compliance log may, for example, be stored in any suitable memory or data store.

At 406 the assessment engine 110 obtains details of other objects at the new destination. In one example, this may include details of other objects in at least one of a virtual destination and a hardware destination. The obtained details may, for example, include details of the type of each object. At 408 the assessment engine 110 obtains characteristics of the new destination. The obtained characteristics may, for example, include a destination identifier enabling the destination, such as a hardware destination, to be uniquely identified. In other examples, the obtained characteristics may include, for example, details of the network access available to the device, details of security settings, and so on.

At 408 the assessment engine 110 stores the obtained details in the compliance log.

Storing such details in the compliance log enables an effective audit of the destinations of individual software objects to be carried out. If subsequently required the data stored in the log can be used to show which software objects were deployed on which destinations and with which other software objects at any given time.

It is important to note, however, that typical object deployment management systems do not maintain such a log since, where compliance with object constraints is not required, there is no reason to maintain such a log.

An example of a virtualization management system 504 according to an example of the present invention will now be described, in greater detail, with reference to FIG. 5. The virtualization management system 504 includes a compliance engine 506, an assessment engine 508, a compliance data store 510, and a destination data store 512.

In a further example, as illustrated in FIG. 6, at least part of the system 504, may be implemented using a microprocessor 602 coupled, via a communication bus 604, to a memory 606, an input/output module 608, and storage 614 and 616. The memory 606 stores compliance engine instructions 610 and assessment engine instructions 612. The instructions 610 and 612 are processor understandable instructions that when executed by the processor 602 provide functionality of a virtualization management system comprising a compliance engine and an assessment engine as described herein.

Operation of the virtualization management system 504 will be further described with additional reference to the FIG. 7.

At 702 the virtualization management system 504 identifies that a software object (106 or 104) is to be moved to a new destination.

In one example, the virtualization management system 504 identifies that an object is to be moved by receiving a notification or alert from an object deployment controller 502.

In a further example, the virtualization management system 504 identifies that an object is to be moved by interrogating the object deployment controller 502, for example, through a suitable interface, for example using a suitable application programming interface (API) (not shown).

In a further example, the virtualization management system 504 identifies that an object is to be moved by intercepting messages sent by the object deployment controller 502.

In a yet further example, the object deployment controller 502 is an integrated part of the virtualization management system 504.

At 704 the virtualization management system 504 identifies a candidate destination to which the object could be moved to.

In one example, the assessment engine 508 identifies a candidate destination by receiving, or obtaining, a candidate destination from the object deployment controller 502.

In a further example, the assessment engine 508 identifies a candidate destination by identifying the technical requirements of the object to be moved, and identifying a destination that meets those technical requirements. For example, the technical characteristics of each available destination in the system 500 may be available from a destination characteristic data store 512. In one example the data store 512 may be a configuration management database. The technical requirements of the object to be moved may, for example, be obtained by accessing CMDBs, application programming interfaces (APIs), or the like.

Table 1 below shows example characteristics of a hardware destination which may include, for example, hardware type, a destination identifier, and other technical characteristics.

TABLE 1
Example Physical Machine Characteristics
HARDWARE DESTINATION CHARACTERISTICS

| CHARACTERISTIC | VALUE |
|---|---|
| Hardware Type: | HP-UX Server |
| Destination Identifier: | Server01 |
| Total Memory Available: | 10 Gb |
| Current available memory: | 2 Gb |
| Processing Power | 5 CPUs allocated |
| Public Network Access? | No |
| . . . | . . . |

Table 2 below shows example characteristics of a virtual destination which may include, for example, a virtual destination identifier and other virtual destination technical requirements.

TABLE 2
Example Virtual Machine Characteristics
VIRTUAL MACHINE CHARACTERISTICS

| CHARACTERISTIC | VALUE |
|---|---|
| Destination Type: | Virtual Machine |
| Destination Identifier: | VirtualMachine01 |
| Total Virtual Memory | 5 Gb |
| Allocated: | |
| Available Virtual memory: | 2 Gb |
| Public Network Access? | No |
| . . . | . . . |

Table 3 below shows example application or object requirements which may include, for example, object type (e.g. application, virtual machine, etc.), object purpose, and object technical requirements.

TABLE 3
Example Software Application Requirements
OBJECT REQUIREMENTS

| CHARACTERISTIC | VALUE |
|---|---|
| Object Identifier: | Application1 |
| Object Type: | Application |
| Object Purpose | Financial transaction |
| | processor |
| Minimum memory | 4 Gb |
| requirements: | |
| Minimum storage | 20 Gb |
| requirements | |
| Object Footprint | 30 Gb |
| Public Network Access | No |
| Required? | |
| . . . | . . . |

At 706 the assessment engine 508 identifies any objects at the identified candidate destination. The objects identified may include both applications and virtual machines. In one example the objects may be identified through interrogation of the data store 512.

At 708 the compliance engine 506 identifies constraints associated with the object to be moved and, at 710, identifies constraints associated with the objects at the candidate destination. Example object constraint data is shown below in Table 4. The object constraint data may include, for example, details of the object purpose, data types processed, data types with which the object is deemed incompatible, etc. The constraint data may, for example, be obtained from the compliance data store 510. In a further example the constraint data may be obtained directly from the objects concerned, for example through use of an appropriate interface or messaging mechanism.

TABLE 4
Example Object Constraint Data
OBJECT CONSTRAINT DATA

| CHARACTERISTIC | VALUE |
|---|---|
| Object Identifier: | Application1 |
| Object Type: | Application |
| Object Purpose | Financial transaction processor |
| Data types processed: | PCI-DSS |
| | Personally Identifiable Data (PII) |
| . . . | . . . |

At 712 the compliance engine 506 determines whether the constraints of the object to be moved and any objects on the candidate destination are compatible with one another. To assist in this, the compliance engine 506 additionally obtains, from the compliance data store 510 details of data type constraints for each data type associated with each of the objects. An example of data type constraint data is shown below in Table 5.

TABLE 5
Example Data Type Constraints
DATA TYPE CONSTRAINTS

| CHARACTERISTICS | COMMENTS |
|---|---|
| Data Type: | PCI-DSS |
| Incompatible data types: | Corporate Financial data |
| Deployment possible on | No |
| destination with public | |
| network access? | |
| Exceptions permitted: | None |
| . . . | . . . |

The data type constraint data defines, for each data type, details of other data types the processing of which is incompatible therewith. The data type constraints may also, if appropriate, positively identify other data types which are deemed compatible data types. The data type constraint data may also define, for example, additional constraints that apply to a particular data type, for example, as to whether the data can be processed on a destination having public Internet access, whether any exceptions or derogations to the constraints are permissible (and under what conditions), etc.

If the compliance engine 506 determines that the constraints are compatible with each other it authorizes (714) the object to be moved to the candidate destination, otherwise (716) the compliance engine 506 instructs the assessment engine 508 to determine an alternative candidate destination.

In the example where the object deployment controller 502 is external to the virtualization management system 504 an authorization or a request to move the object to the candidate destination may be sent to the object deployment controller 502. In the example where the object deployment controller 502 is integral to the virtualization management system 504 the compliance engine 506 or assessment engine 508 may directly instruct the object deployment controller 502 to move the object to the candidate destination.

Details of any successful and unsuccessful object moves may, in one example, be stored in a log (not shown) for subsequent auditing purposes.

As described above, it will be appreciated that examples and embodiments of the present invention can be realized in the form of hardware, software or a combination of hardware and software. As described above, any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples of the present invention. Examples of the present invention may be conveyed electronically via any medium such as a communication signal carried over a wired or wireless connection and examples suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A method of moving one of a plurality of software objects deployed among a plurality of object destinations in a computing system, the method comprising:
identifying a deployed software object to be moved to a new object destination;
identifying a candidate object destination;
identifying other software objects deployed on the candidate object destination;
identifying a constraint associated with software object to be moved;
identifying a constraint associated with software objects deployed on the candidate object destination;
determining whether the identified constraints are compatible; and
authorizing the move of the software object to be moved where it is determined that the constraints are compatible.

2. The method of claim 1, wherein a software object is one of a software application and a virtual machine.

3. The method of claim 1, wherein the computing system comprises a plurality of physical computing devices, and further wherein a software object destination is one of a virtual machine and a physical computing device.

4. The method of claim 3, wherein where the software object to be moved is a virtual machine, the step of authorizing the move further comprising authorizing the move of the virtual machine and all objects deployed thereon to the candidate object destination.

5. The method of claim 1, wherein step of identifying a candidate object destination is based on characteristics of the identified software object and object destination characteristics.

6. The method of claim 1, further comprising moving the identified software object to the identified candidate destination.

7. The method of claim 1, wherein the identified constraints include at least one of: business constraints, security constraints, legal constraints, industry constraints, technical constraints, non-technical constraints, and data type constraints.

8. The method of claim 1, further comprising, recording details of the object moved, details of the destination object to which it was moved, and details of other objects on the destination object, in a log.

9. Apparatus for moving one of a plurality of software objects deployed among a plurality of object destinations in a computing system,
the apparatus comprising an assessment module to:
obtain an indication that a software object deployed on a destination object is to be moved to a different object destination;
identify a new potential object destination for the software object to be moved;
obtain, from a compliance data store, constraint data associated with the software object to be moved;
obtain, from the compliance data store, constraint data associated with other software objects deployed on the potential object destination;
determine whether the obtained constraints are compatible; and
where so determined, authorize the software object to be moved.

10. The apparatus of claim 9, wherein the software objects include software applications and virtual machines, and wherein the object destinations include virtual machines and physical computing devices.

11. The apparatus of claim 10, wherein the assessment module identifies a new potential object destination based in part on characteristics of the software object to be moved and characteristics of object destinations, the characteristics being obtained from a configuration management database, CMDB.

12. The apparatus of claim 10, further comprising an object deployment controller, and wherein the assessment module identifies a new potential object destination directly from the object deployment controller.

13. The apparatus of claim 10, further comprising obtaining the constraint data from a constraint data store.

14. The apparatus of claim 10 further comprising a data log, the assessment module being arranged to store in the data log details of the destination object to which the object to be moved was moved and details of other objects on the destination object.

15. A tangible, machine-readable medium that stores machine-readable instructions executable by a processor to provide a method of moving one of a plurality of software objects deployed among a plurality of object destinations in a computing system, the tangible machine-readable medium comprising:
machine readable instructions that, when executed by the processor, identify a software object deployed on an object destination to be moved to a new object destination;
machine readable instructions that, when executed by the processor, identify a candidate object destination to which the object to be moved may be moved;
machine readable instructions that, when executed by the processor, identify software objects currently deployed on the candidate object destination;
machine readable instructions that, when executed by the processor, identify constraint data associated with software object to be moved;
machine readable instructions that, when executed by the processor, identify constraint data associated with software objects deployed on the candidate object destination;
machine readable instructions that, when executed by the processor, determine whether the identified constraints are compatible; and
machine readable instructions that, when executed by the processor, authorize the move of the software object to be moved to the candidate object destination where it is determined that the constraints are compatible.
